(19) United States
(12) Patent Application Publication
(10) Pub. No.: US 2013/0130088 A1
(43) Pub. Date: May 23, 2013

(54) BATTERY

(71) Applicant: Katsuo Hashizaki, Tokyo (JP)

(72) Inventor: Katsuo Hashizaki, Tokyo (JP)

(73) Assignee: MITSUBISHI HEAVY INDUSTRIES, LTD., Tokyo (JP)

(21) Appl. No.: 13/813,211

(22) PCT Filed: Sep. 2, 2011
(86) PCT No.: PCT/JP2011/070038

§ 371 Date: Jan. 30, 2013

(30) Foreign Application Priority Data
Sep. 3, 2010 (JP) 2010-198151

(51) Int. Cl. H01M 10/50

(52) U.S. Cl. CPC H01M 10/5042
USPC 429/120

(57) ABSTRACT

There is disclosed a battery including: a laminated electrode body (3) in which a positive electrode plate (6) and a negative electrode plate (5) are laminated through a separator (4); a battery container (18) that accommodates the laminated electrode body (3); an electrolytic solution that is accommodated in the battery container (18); and insulating sheets (7, 8, and 9) that is configured to serve as an insertion guide during accommodation of the laminated electrode body (3) in the battery container (18), and is disposed between the laminated electrode body (3) that is accommodated and the battery container (18), and has openings (14 and 15) formed to be adjacent to the bottom of the battery container (18) in a state where the insulating sheet is disposed therebetween. Convection of the electrolytic solution is promoted by the openings (14 and 15).

### Technical Field

The present invention relates to a battery in which a positive electrode plate and a negative electrode plate are laminated through a separator.

Priority is claimed on Japanese Patent Application No. 2010-198151, filed Sep. 3, 2010, the content of which is incorporated herein by reference.

### BACKGROUND ART OF THE INVENTION

As batteries having a configuration (hereinafter, referred to as a laminated electrode body) in which electrode plates (a positive electrode plate and a negative electrode plate) are laminated through a separator, there is a winding type and a lamination type. The winding type battery has a configuration in which one sheet-shaped positive plate and one sheet-shaped negative plate are laminated through a separator and then are rounded to be accommodated in a battery container. In addition, the lamination type battery has a configuration in which a plurality of sheet-shaped positive electrode plates and a plurality of sheet-shaped negative electrode plates are sequentially laminated through a separator, respectively, and then are accommodated in a battery container without being rounded. In addition, members making up the battery container include a container main body having an opening and a lid that closes the opening. The laminated electrode body is accommodated inside the container main body and then the opening is closed with the lid, whereby the battery container is hermetically sealed.

A plastic battery container or a metallic battery container may be given as an example of the battery container that accommodates the laminated electrode body. In a case of the battery container (also, referred to as a battery casing) that is formed from a metal such as aluminum, an insulating plate or an insulating sheet having an insulating property may be disposed to be interposed between the laminated electrode body and the battery casing in order for the electrode plates of the laminated electrode body not to come into contact with the battery casing.

At this time, in the case of the lamination type battery, in order to prevent the plurality of positive electrode plates or negative electrode plates from deviating from a predetermined position, that is, in order to prevent lamination deviation when the manufactured battery is used, at least two plate-shaped insulating plates or insulating sheets (described as a pressurizing sheet or an auxiliary sheet in the following Patent Document 1) having the same shape as the electrode plates are prepared, and the laminated electrode body may be interposed and compressed between these insulating sheets or the like.

### Patent Document

Patent Document 1: Japanese Unexamined Patent Application, First Publication No. 2008-91099

### DETAILED DESCRIPTION OF THE INVENTION

### Problems to be Solved by the Invention

However, in the battery provided with the laminated electrode body, when discharging (or charging) is performed during use, heat is generated from the electrode plates. In addition, when the heat is confined in the central portion of the laminated electrode body that is accommodated in the battery container, this may be a factor that causes failure of a battery (a decrease in battery performance, shortening of battery lifespan, and the like).

An attempt has been made to gradually dissipate heat from the central portion to the outside of the battery container by cooling the battery container with air cooling, water cooling, or the like from the outside, but in the configuration in which the insulating plate or the insulating sheet that is interposed between the laminated electrode body and the battery container as described above is disposed, since the insulating body has heat conductivity lower than that of a metallic material, a degree of heat dissipation is not yet sufficient.

Particularly, similarly to the configuration disclosed in Patent Document 1, in a configuration in which a plurality of laminated electrode bodies are laminated, each being interposed between the two plate-shaped insulating sheets or the like having the same shape as the electrode plates, heat conduction of the laminated electrode bodies to each other is hindered by the insulating sheets or the like, and thus it can be said that heat in the central portion of the battery container is easily contained.

When the degree of heat dissipation is not sufficient, there is a concern that failure may occur in the battery, and thus it is necessary to realize heat dissipation sufficiently.

Therefore, an object of the invention is to provide a battery in which heat dissipation from the central portion of the battery container to the outside of the battery container is effectively performed, and thus failure of the battery (a decrease in battery performance, shortening of lifespan, and the like) is suppressed.

### Solution for Solving the Problems

According to an embodiment of the invention, there is provided a battery including: a laminated electrode body in which a positive electrode plate and a negative electrode plate are laminated through a separator; a battery container that accommodates the laminated electrode body; an electrolytic solution that is accommodated in the battery container; and an insulating sheet that is configured to serve as an insertion guide during accommodation of the laminated electrode body in the battery container, and is disposed between the laminated electrode body that is accommodated and the battery container, and has an opening formed to be adjacent to the bottom of the battery container in a state where the insulating sheet is disposed between the laminated electrode body and the battery container, wherein convection of the electrolytic solution is promoted by the opening.

Therefore, since convection of the electrolytic solution is promoted due to the opening, heat generated in the central portion of the battery container is transferred from the central portion of the battery container to the battery container by not only heat conduction but also the electrolytic solution. As a result, heat dissipation to the outside of the battery container may be effectively performed.

### Advantageous Effects of the Invention

In the invention, since heat dissipation from the central portion of the battery container to the outside of the battery container may be effectively performed, failure of the battery (a decrease in battery performance, shortening of lifespan, and the like) is suppressed, and thus a battery of which safety is improved and which has excellent performance may be provided.

### BRIEF DESCRIPTION OF THE DRAWINGS

FIG. 1 is a projected perspective view of a battery of an embodiment.

FIG. 2 is a developed perspective view of a battery block that is accommodated in the battery of the embodiment.

FIG. 3 is a view illustrating motion of an electrolytic solution inside the battery of the embodiment.

FIG. 4 is a developed view of an insulating sheet 26 in a modification example (first modification example) of the battery of the embodiment.

FIG. 5 is a developed view of insulating sheets 27 and 28 in a modification example (second modification example) of the battery of the embodiment.

FIG. 6 is a developed view of insulating sheets 27′ and 28′ in a modification example (third modification example) of the battery of the embodiment.

### DESCRIPTION OF EMBODIMENTS

Hereinafter, an embodiment of a battery relating to the invention will be described with reference to the attached drawings. In addition, the invention is not limited to the embodiment, and various kinds of modifications may be made without departing from the gist of the invention.

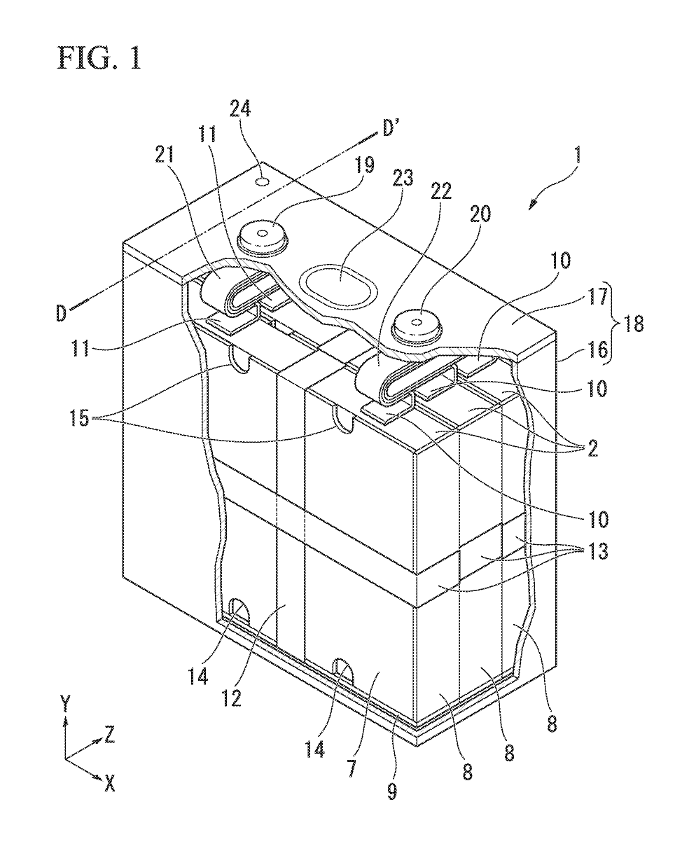

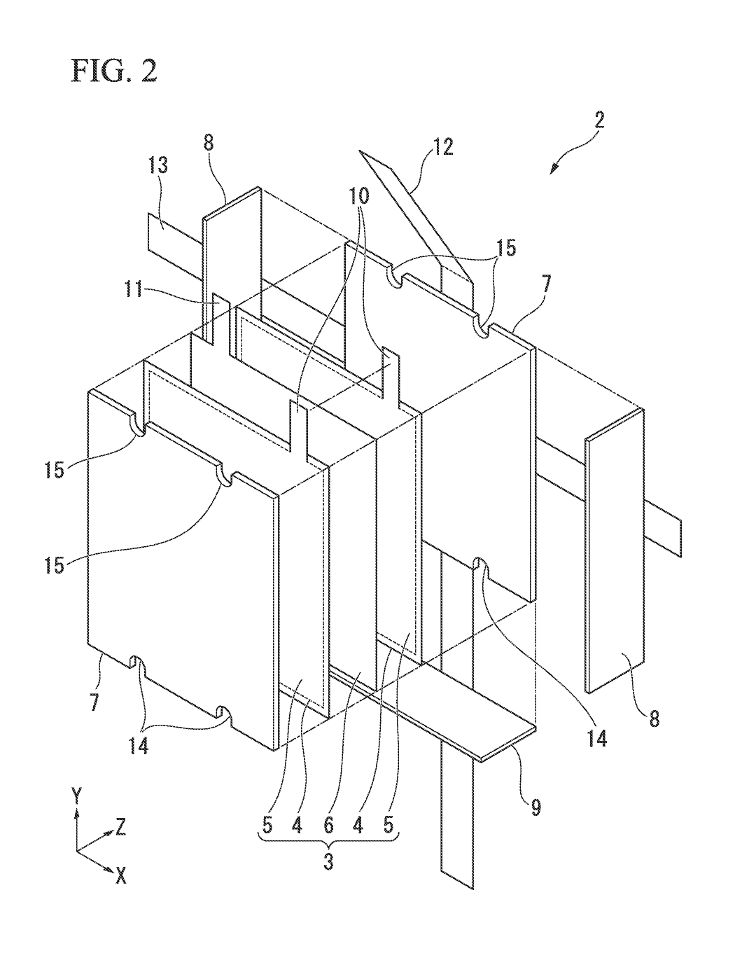

FIG. 1 shows a projection perspective view of a battery 1 of this embodiment and FIG. 2 shows a perspective view illustrating a configuration of one battery block 2 (including a laminated electrode body 3) that is disposed in the battery 1. The battery 1 is a battery (refer to FIG. 1) that has a configuration in which three units are laminated, each unit including one battery block 2, and herein, the battery 1 will be described as a lithium ion secondary battery.

First, the battery block 2 will be described with reference to FIG. 2. The battery block 2 includes the laminated electrode body 3 and a pair of insulating sheets 7 that are disposed with the laminated electrode body 3 interposed therebetween at least from a Z direction to be described later.

The laminated electrode body 3 has a configuration in which the surface of an approximately rectangular negative electrode plate 5 is encapsulated by a sac-like separator 4, an approximately rectangular positive electrode plate 6 in which a positive electrode active material containing a lithium element, for example, lithium manganate or the like is set as a positive electrode active material is laminated from an upper side of the separator 4, and the approximately rectangular negative electrode plate 5 which is encapsulated by the sac-like separator 4 and in which artificial graphite or the like is set as a negative electrode active material is further laminated over the positive electrode plate 6. That is, the negative electrode plate 5, the separator 4, the positive electrode plate 6, the separator 4, and the negative electrode plate 5 are sequentially laminated. Since the negative electrode plate 5 has an approximately rectangular shape, the sac-like separator 4 also has an approximately rectangular shape. The negative electrode plate 5 is larger than the positive electrode plate 6, and the separator 4 is larger than the negative electrode plate 5. In addition, as shown in the drawing, in a case where a corresponding lamination direction is set to the Z direction, when viewed from the Z direction, the positive electrode plate 6 is disposed within a surface of the negative electrode plate 5 (hereinafter, this state is referred to a state in which an electrode plate is disposed at a predetermined position).

Here, the laminated electrode body 3 has a configuration in which two negative electrode plates 5 and one positive electrode plate 6 are sequentially laminated through a separator. However, the number of the electrode plates may be arbitrarily changed in accordance with a design specification as long as a plurality of negative electrode plates 5 and a plurality of positive electrode plates 6 are laminated through a separator. In addition, here, the sac-like separator 4 is used, but the separator 4 may not have a sac-like shape as long as the separator 4 is disposed between the negative electrode plate 5 and the positive electrode plate 6.

As described above, the negative electrode plate 5 and the positive electrode plate 6 have an approximately rectangular shape, but these are formed in a state in which electrode tabs (a positive electrode tab and a negative electrode tab) that are used to electrically connect to electrode terminals (a positive electrode terminal and a negative electrode terminal) to be described later are connected to the approximately rectangular electrode plates and protrude therefrom. Here, when the electrode plates (the positive electrode plate and the negative electrode plate) are disposed on an XY plane, a negative electrode tab 10 that is formed in the negative electrode plate 5 is disposed to deviate from the center of width in an X-axis direction to a +X direction and to protrude from the negative electrode plate 5 in a +Y direction. On the other hand, a positive electrode tab 11 that is formed in the positive electrode plate 6 is disposed to deviate from the center of the width in the X-axis direction to a −X direction and to protrude from the positive electrode plate 6 in the +Y direction.

The laminated electrode body 3 is sandwiched by a pair of insulating sheets 7 from both surfaces in the Z direction that is a lamination direction, and an insulating tape 12 is attached to the sandwiched laminated electrode body 3 to pass through the central portion of the width in the X-axis direction of the insulating sheets 7 and to surround the insulating sheets 7. Due to this, each battery block 2, whose state in which the laminated electrode body 3 is pressed between the pair of insulating sheets 7 and is fixed and maintained by the insulating tape 12, is formed. Each of the insulating sheets 7 has an approximately rectangular shape and is larger than the negative electrode plate 5, and when viewed in the Z direction, the negative electrode plate 5 is disposed within a plane of the insulating sheet 7. Due to the pressing, the electrode plates may be disposed at a predetermined position and may be maintained without deviation during manufacturing of a battery.

In addition, each of the insulating sheets 7 is provided with openings 14 and 15 formed by cutting away parts of the insulating sheets 7 from two sides, which are present in the Y-axis direction, toward the inside of the insulating sheet 7 along the Y-axis. Detailed configuration and function of the openings 14 and 15 will be described later.

In addition, here, an insulating sheet 9 is disposed on an XZ plane of a bottom surface side of the laminated electrode body 3 (on a side opposite to the side from which the electrode tab of the electrode plate protrudes in the Y-axis direction) and is fixed together with the pair of insulating sheets 7 with the insulating tape 12. The insulating sheet 9 has an approximately rectangular shape having substantially the same length as the width in the X-axis direction of each of the insulating sheets 7 in the X-axis direction, and has substantially the same length in the Z-direction as a dimension obtained by adding the Z-directional thickness of the laminated electrode body 3 and the thickness of the two insulating sheets 7. This insulating sheet 9 is particularly useful when the battery container is a battery casing, and it is possible to prevent the laminated electrode body 3 from coming into contact with an inner wall of the battery casing and being short-circuited.

Similarly, here, a pair of insulating sheets 8 are disposed on a YZ plane in such a manner that the laminated electrode body 3 is sandwiched by the pair of insulating sheets 8 from both sides (two sides of the electrode plate in the X-axis direction) of the laminated electrode body 3, and are fixed together with the insulating sheets 7 with an insulating tape 13. The insulating sheets 8 have an approximately rectangular shape having substantially the same length in the Y-axis direction as the width in the Y-axis direction of each of the insulating sheets 7, and has substantially the same length in the Z-direction as a length obtained by adding the Z-directional thickness of the laminated electrode body 3 and the thickness of the two insulating sheets 7. Similarly to the insulating sheet 9, these insulating sheets 8 are also particularly useful in a case where the battery container is a battery casing, and it is possible to prevent the laminated electrode body 3 from coming into contact with an inner wall of the battery casing and being short-circuited.

In a case where the battery container is not a conductive battery casing, these insulating sheets 8 and 9 may not be provided.

In addition, the insulating sheets 7, 8, and 9 are formed from a plastic resin such as propylene and polyethylene that has resistance to the electrolytic solution and has an insulation property. In addition, among the insulating sheets 7, 8, and 9, it is not necessary for the insulating sheets 8 and 9 to be sufficiently-thick, but it is preferable that the insulating sheet 7 be sufficiently-thick so as to perform the pressing sufficiently as described above. For example, and it is preferable to have rigidity to a degree at which a deformation amount due to its own weight is small and thus the insulating sheet 7 does not sag to a vertically downward side while horizontally maintaining a surface in a case where one end of the insulating sheet 7 is maintained and the surface of the insulating sheet 7 is horizontally disposed. Specifically, it is preferable to have a thickness of approximately 1 mm or more.

Furthermore, similarly, the insulating tapes 12 and 13 are tapes that are formed by using a plastic resin having resistance to the electrolytic solution and an insulation property, and the number of the tapes and positions at which the tapes are adhered may be appropriately changed according to a design in order to maintain the pressed state.

Next, the battery 1 will be described with reference to FIG. 1. Here, three battery blocks 2 that are shown in FIG. 2 are accommodated in the battery 1. The number of battery blocks 2 that are accommodated may be appropriately changed to one, two, four or more according to a design.

The battery container 18 includes a container main body 16 having an opening and a lid 17 that closes the opening. After the three battery blocks 2 are sequentially or simultaneously accommodated in the container main body, the opening is closed with the lid to hermetically close the battery container. In a case where the battery container 18 is formed from a metal, the container main body 16 and the lid 17 are welded by laser welding or the like to hermetically close and seal the battery container 18, and in a case where the battery container 18 is formed from plastic, the battery container 18 is adhered or thermally adhered (melted with heat and adhered) to hermetically close and seal the battery container 18. In addition, since the battery blocks 2 have an approximately rectangular parallelepiped shape, the battery container 18 also has an approximately rectangular parallelepiped shape.

In the battery blocks 2 of this embodiment, the insulating sheets 7, 8, and 9 are disposed at the periphery of the laminated electrode body 3 (the insulating sheets 7 and 8 are disposed to face an inner wall of a side surface of the container main body 16 and the insulating sheet 9 is disposed to face an inner wall of the bottom surface of the container main body 16). These insulating sheets have a function as an insertion guide (a function of coming into contact with the container main body 16 during insertion of the battery blocks 2 in the container main body 16 so as to make the insertion easy and to prevent bending or the like of the electrode plates during the insertion) and a function as a protective sheet (a function of supporting the electrode plates even in a case where vibration or the like occurs during battery usage and prevents bending or the like of the electrode plates). Therefore, production becomes easy when the battery blocks 2 are inserted in the container main body 16, and thus production capacity is also improved. In addition, battery failure (electrode short circuit or the like) due to the bending of the electrode plates may also be prevented. In addition, any function may be further reinforced by making the insulating sheets be thick enough to be stiff. In this embodiment, since the insulating sheet 7 is sufficiently-thick, this function may be effectively exhibited.

The lid 17 has electrode terminals (a positive electrode terminal 19 and a negative electrode terminal 20), which are disposed to penetrate through the lid 17, are formed in advance. In addition, each positive electrode tab 11 of the three battery blocks 2 is connected to a positive electrode lid 21 that is connected to the positive electrode terminal 19, whereby each positive electrode plate 6 and the positive electrode terminal 19 are electrically connected to each other. In addition, each negative electrode tab 10 of the three battery blocks 2 is connected to a negative electrode lid 22 that is connected to the negative electrode terminal 20, whereby each negative electrode plate 5 and the negative electrode terminal 20 are electrically connected to each other.

In addition, a safety valve 23 is formed in the lid 17 in advance. This safety valve 23 is prepared for a case in which gas occurs inside the battery container 18 during using the battery 1, and in a case where the inside of the battery container 18 reaches a predetermined gas pressure, the safety valve 23 is broken to discharge the gas, thereby preventing the battery container 18 itself from being ruptured.

Furthermore, a liquid injection port 24 that injects the electrolytic solution into the container main body 16 is formed in the lid 17 in advance. After the battery container 18 is hermetically closed as described above, a predetermined amount of the electrolytic solution is injected from the liquid injection port 24 and then the liquid injection port 24 is hermetically closed by welding, thermal adhesion, or the like. Although not shown in FIG. 1, the battery 1 is completed with a configuration of FIG. 1 in a state in which the electrolytic solution is injected and then the liquid injection port 24 is hermetically closed (a predetermined amount of electrolytic solution is accommodated in the battery 1 in the completed state).

Then, a detailed configuration and a function of the openings 14 and 15 that are provided in the battery 1 will be described.

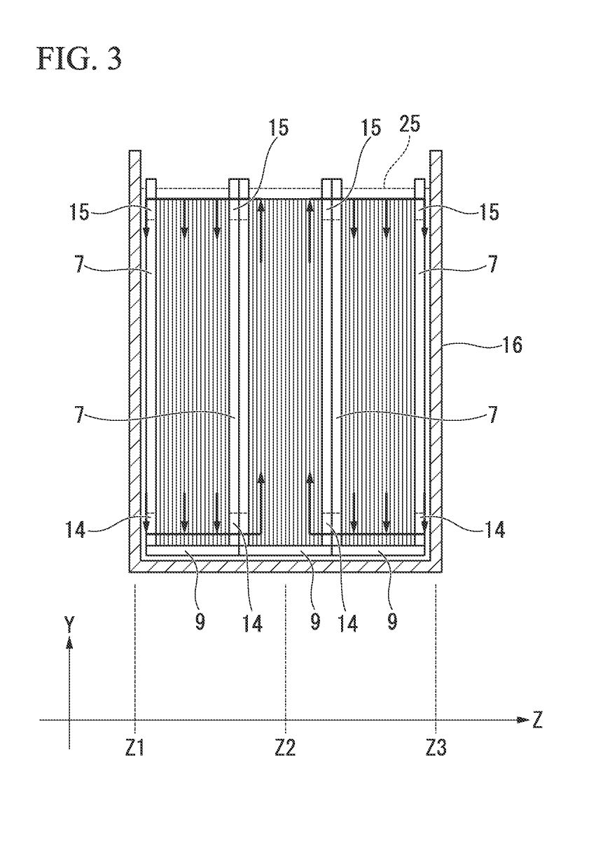

FIG. 3 shows a cross-sectional view of the battery 1 shown in FIG. 1 in a YZ plane including a D-D′ line. However, the lid 17 and the insulating tape 13 are omitted for ease of explanation. In addition, the electrolytic solution is sufficiently injected in order for all of the surfaces of the negative electrode plate 5 to be immersed, and here, a liquid surface is designated as a liquid surface 25.

When the battery 1 is used, that is, discharging (or charging) is performed, heat is generated inside the battery block 2. In addition, the more the battery block 2 is laminated, the further battery block 2 at the central portion is distant from the wall surface of the container main body 16. Therefore, even when the battery container 18 is cooled by air cooling, water cooling, or the like, the heat of the battery block 2 at the central portion may not be easily dissipated.

Therefore, in the battery 1 of the invention, the openings 14 and 15 formed in the insulating sheets 7 of the plurality of battery blocks 2 are formed, and convection of the electrolytic solution is positively used, thereby promoting heat dissipation of each battery block 2. Since convection is used, the opening 14 is particularly important.

The reason why the opening 14 is particularly important will be described with reference to FIG. 3. The wall surface of the battery container 18 in FIG. 3 is disposed at each position of Z1 and Z2 on the Z-axis, but among the three battery blocks 2 that are disposed, the central battery block 2, that is, a battery block 2 that is present at a position of Z3 is disposed at a position at which heat tends to be contained. On the other hand, since the outside of the battery container 18 is exposed to ambient air, generally, the temperature is low (including a case in which the battery container 18 is artificially cooled from the outside with an air cooling device or a water cooling device), and a temperature gradient from a high temperature side to a low temperature side in a direction from Z3 toward Z1 and a direction from Z3 toward Z2 occurs on the Z-axis. As a result, in the vicinity of Z1 and Z2 of the battery container, a downward flow of the electrolytic solution due to cooling tends to occur on the Y-axis, and a temperature at the position of Z3 is higher than that in the vicinity of the battery container, and thus an upward flow tends to occur on the Y-axis.

Therefore, the electrolytic solution tends to flow as indicated by arrows in FIG. 3. At this time, when the opening 14 is not disposed in the insulating sheets 7, since the insulating sheets 7 are plate-shaped insulating sheets having the same shape as the electrode plates, the flow of the electrolytic solution is blocked by the insulating sheets. However, when the opening 14 is provided in the insulating sheets 7, places at which the flow of the electrolytic solution is not blocked are present. As a result thereof, a flow path of the electrolytic solution is formed and thus convection is promoted.

In addition, the reason why the opening 14 is formed at each corner (a side, which is closest to the bottom of the battery container 18, of each of the insulating sheets 7 on the Y-axis) is that the electrolytic solution is made to convect in a relatively wide range and thus heat dissipation is effectively performed.

Due to this, the convection of the electrolytic solution as indicated by arrows in the drawing may be promoted. In regard to the flow of the electrolytic solution in a lamination direction of the laminated electrode body 3, for example, in a case in which the peripheries of two sheets of separators are thermally adhered to form a sac-like shape, the convection occurs when the electrolytic solution passes through the vicinity of a portion including a thermally adhered portion that is present at the periphery of the negative electrode plate 5 encapsulated by the sac-like separator 4.

In addition, similarly to the opening 14, the opening 15 is also formed to form a flow path, but in a case where the liquid surface 25 of the electrolytic solution is present on a cover 17 side in relation to an end of each insulating sheet 7 when viewed in the Y-axis direction, since sufficient flow paths are already formed, the opening 15 may not be formed.

In this manner, when the convection of the electrolytic solution is promoted, heat generated at each battery block 2 is transferred to the vicinity of the wall surface of the battery container by not only heat conduction between materials but also the electrolytic solution. As is clear from a configuration in which the battery blocks 2 are accommodated in the battery container, the total length of the battery blocks 2 that are accommodated is smaller than an inner diameter of the battery container. That is, the electrolytic solution is also present between the wall surface of the battery container and the insulating sheets 7 that are closest to the battery container, and thus the convection of the electrolytic solution is also promoted. Therefore, the battery container and the electrolytic solution to which heat is transferred directly come into contact with each other, and thus the heat that is transferred to the wall surface of the battery container due to the convection is effectively dissipated to the outside of the battery container. That is, heat exchange may be promoted by positively using not only heat conduction but also convection of the electrolytic solution.

In addition, since the opening 14 is provided to form a flow path of the electrolytic solution and make convection easy, it is not limited to a semi-circle shape as shown in FIGS. 1 and 2. Any shape is possible as long as the opening 14 is intended to form a flow path of the electrolytic solution and to make convection easy, for example, a triangular shape or a rectangular shape is also possible. Specifically, when a shape has a width of approximately 1 cm or more, and a height of approximately 1 cm or more, this is effective for forming a flow path that promotes convection. The number of openings 14 is also not limited to two in number as shown in FIGS. 1 and 2, and a plurality of openings 14 of three or more may be formed so as to form a sufficient flow path. In addition, only one opening 14 may be formed by cutting away a part of the insulating sheet 7 with a length of approximately half of that of a side in the X-axis direction so as to form a sufficient flow path. However, it is preferable to design the shape of the opening 14 in consideration of rigidity of the insulating sheet 7 in order for the opening 14 to exhibit a function as an insertion guide and a function as a protective sheet that prevents bending of the electrode plates.

In the case of being formed, it is advantageous that the opening 15 has the same shape as the opening 14 from an aspect of manufacturing the battery 1. In addition, the openings 14 and 15 may have shapes different from each other as long as convection may be promoted.

So as to further promote and activate convection of the electrolytic solution, a penetration hole that is comparable to the opening 14 may be formed inside the insulating sheets 7. The shape of the penetration hole may be any shape as long as it forms a flow path of the electrolytic solution and makes convection easy, and thus the shape may be a circular shape, a triangular shape, or a rectangular shape. However, it is preferable to design the shape of the penetration hole in consideration of the rigidity of the insulating sheets 7 in order for the opening 14 to exhibit a function as an insertion guide and a function as a protective sheet that prevents bending of the electrode plates. In a case where the insulating sheets 8 are disposed, when an opening similar to the opening 14 or 15 of the insulating sheets 7 is formed, convection of the electrolytic solution becomes easier and thus this is effective for heat dissipation. In this case, the advantage of the configuration in which the penetration hole is formed inside the insulating sheets 8 is true of the insulating sheet 7.

In addition, in the above-described configuration, when the insulating sheet itself is formed as a finely porous sheet (a pore size is approximately 20 μm), this is more effective for heat dissipation in addition to the effect of the openings 14 and 15 or the penetration hole. Convection of the electrolytic solution is not particularly activated with only the porous insulating sheet in which the opening 14 and the like are not provided, but in a case where the insulating sheet in which the opening 14 and the like are formed is also porous, an auxiliary effect with respect to heat dissipation may be further obtained due to a minute amount of electrolytic solution passing through fine holes compared to a case in which the insulating sheet is not porous.

As described above, in the battery of this embodiment, since a flow path of the electrolytic solution is formed in the opening 14 and thus convection of the electrolytic solution is made to be easy and is promoted, heat that is generated in each battery block 2 may be effectively dissipated to the outside of the battery container due to the electrolytic solution. Therefore, battery failure due to heat generated inside the battery container is prevented from occurring and thus a battery in which safety is improved may be provided.

### First Modification Example

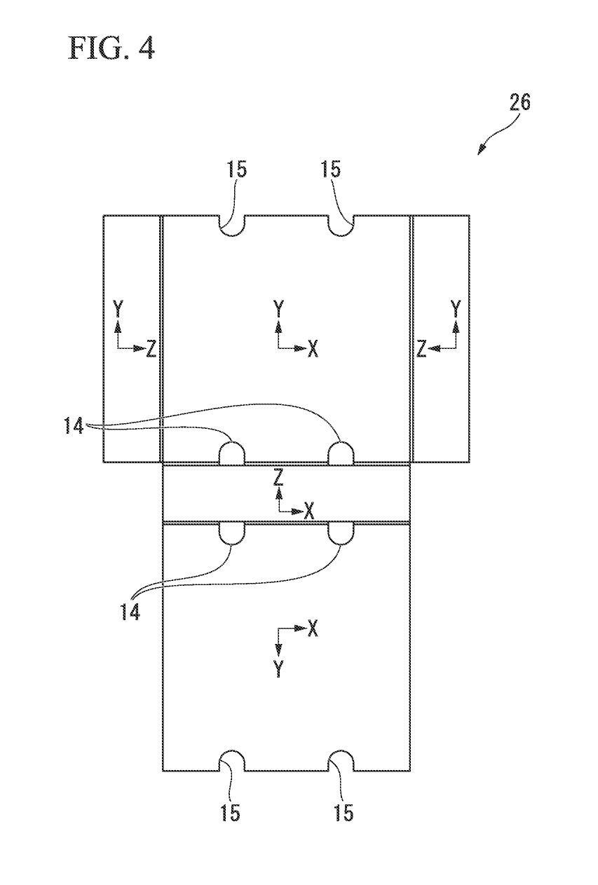

Next, a first modification example of the battery according to the above-described embodiment will be described with reference to FIG. 4.

In the above-described embodiment, the insulating sheets 7, 8, and 9 are disposed as independent members, but in this modification example, an insulating sheet 26 in which the insulating sheets 7, 8, and 9 are integrally formed is used, and thus assembly efficiency during manufacturing the battery may be improved. Other configurations are same as the battery 1 of the above-described embodiment, and thus description thereof will be omitted.

In the insulating sheet 26, portions that connects portions corresponding to the insulating sheets 7, 8, and 9 may have a thickness that is smaller than that of the corresponding portions, and thus may be easily bent. This configuration may be easily realized by pouring a plastic resin into a mold. Alternatively, the insulating sheets 7, 8, and 9 that are prepared as independent members, may be integrally formed by thermally adhering these sheets in an appropriate manner.

### Second Modification Example

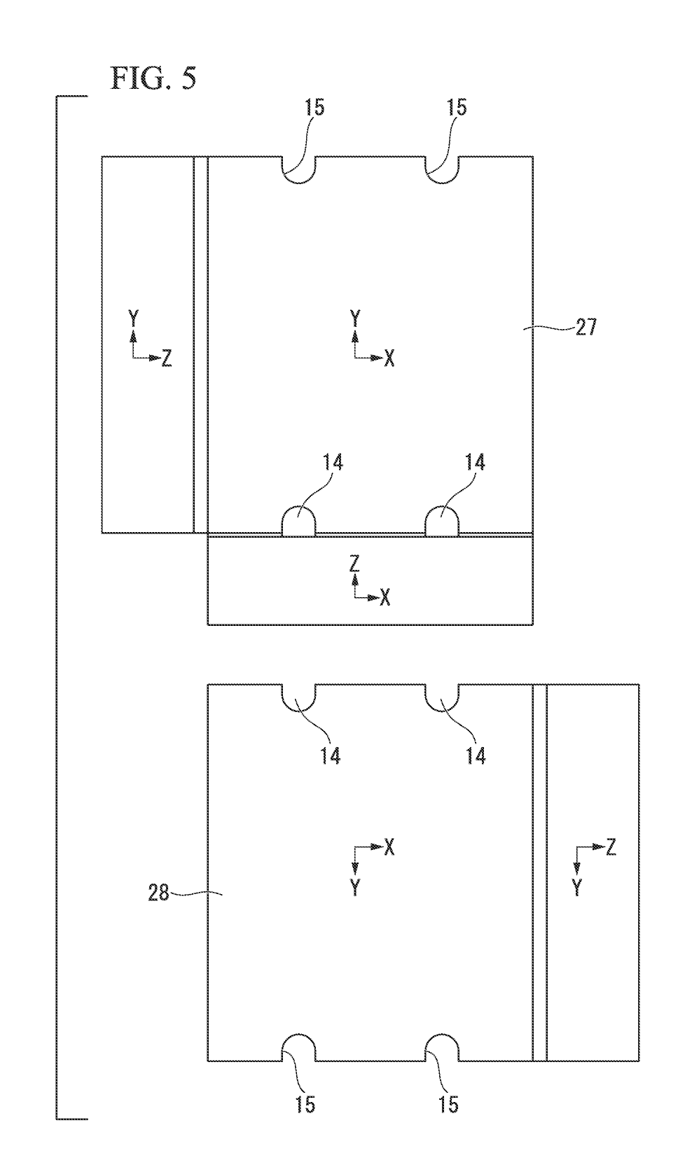

Next, a second modification example of the battery according to the above-described embodiment will be described with reference to FIG. 5.

In this modification example, the insulating sheet 26 shown in the first modification example is divided into two portions including an insulating sheet 27 and an insulating sheet 28 that are separate bodies. Other configurations are the same as the first modification example, and thus description thereof will be omitted.

In a secondary battery, when charging and discharging are performed over a long period of time, a phenomenon in which the laminated electrode body 3 swells in a lamination direction is known. Since the insulating sheet 26 that is used in the first modification example is integrally formed, it is not easy to follow the swelling, and there is a concern in that battery failure may occur according to circumstances. Therefore, two portions that are divided are provided to realize followability with respect to the swelling. In addition, in this modification example, the insulating tape 12 or 13 that fixes and maintains the insulating sheets 27 and 28 and the laminated electrode body 3 is effective for a case in which the battery becomes loose due to use over a long period of time.

### Third Modification Example

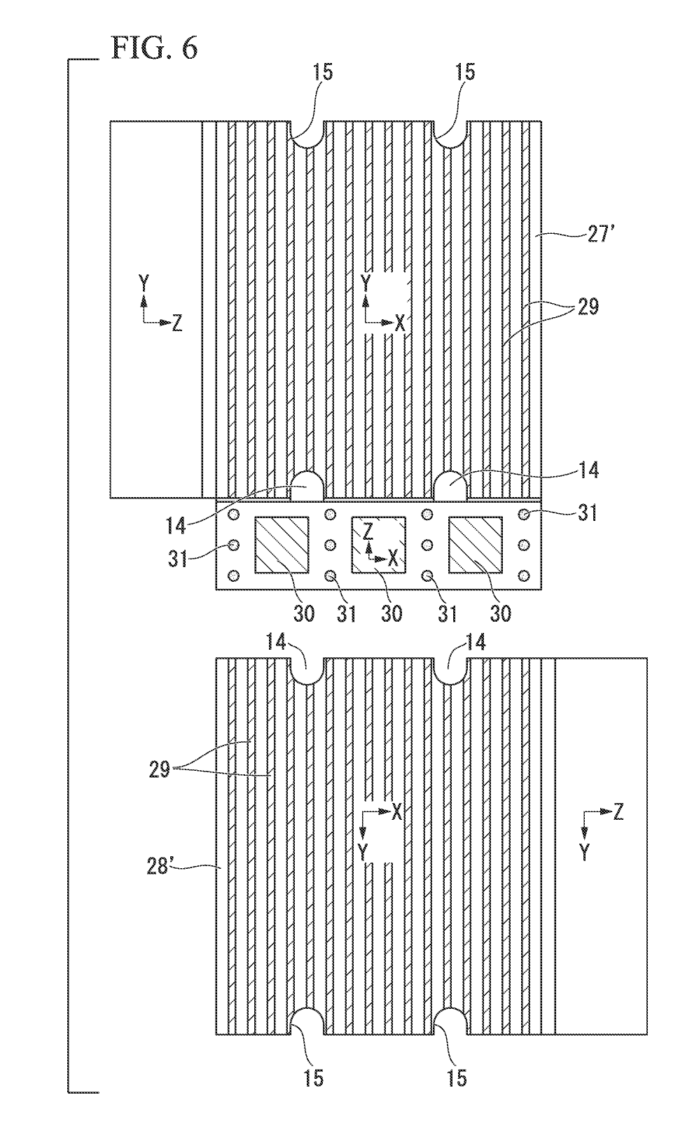

Next, a third modification example of the battery according to the above-described embodiment will be described with reference to FIG. 6.

Insulating sheets of this modification example are similar to the insulating sheet 27 and the insulating sheet 28 of the second modification example, but each concave portion 29 is formed along the Y axis so as to further promote convection (convection in the Y axis direction) of the electrolytic solution over the bottom and the lid directions of the battery container 18. In addition, in this modification example, at a portion corresponding to the insulating sheet 9 of the above-described embodiment (that is, a portion that is disposed between the bottom of the battery container 18 and the laminated electrode body 3), a rectangular penetration hole 30 that penetrates through the corresponding portion, and a plurality of convex portions 31 having a shape protruding from a surface of the corresponding portion are formed.

The concave portion 29 and the penetration hole 30 serve as a groove or a flow path through which the electrolytic solution passes easily. In addition, the convex portions 31 are disposed between a plane of a portion corresponding to the insulating sheet 9 and the bottom of the battery container 18 and support the plane (at least three or more convex portions 31 are appropriately disposed, and the plane is supported at three or more points), thereby making the corresponding plane enter a state of floating up from the bottom of the battery container 18 (a state in which the laminated electrode body 3 is also floated up from the bottom of the battery container 18). Therefore, a space is formed between the corresponding plane and the bottom of the battery container 18, and thus, a flow path that promotes convection of the electrolytic solution may be formed at the space.

FIG. 6 shows insulating sheets 27′ and 28′ having a configuration in which the concave portion 29, the penetration hole 30, and the convex portions 31 are formed in the insulating sheets 27 and 28. Other configurations are the same as the second modification example, and thus description thereof will be omitted.

From a viewpoint of further promoting the heat exchange, it is preferable that at least in the insulating sheet 27′ or 28′ that is closest to the wall surface of the battery container 18, the concave portion 29 be disposed to face the inner wall of the battery container 18.

In addition, when the concave portion 29 is formed not only in one side surface of the insulating sheets 27′ and 28′ but also in both surfaces thereof, convection of the electrolytic solution is further promoted.

The shape of the penetration hole 30 is set to a rectangular shape, but any shape such as a circular shape and a triangular shape is possible as long as a flow path of the electrolytic solution is formed and thus convection is easily performed. In addition, not only the penetration hole 30 but also a shape (a cut-out shape) formed at one end of a side similarly to the openings 14 and 15 may be further provided in a plane at a portion corresponding to the insulating sheet 9 so as to make the convection further easy.

The concave portion 29, the penetration hole 30, the convex portions 31, and the cut-out shape may be formed at corresponding portions of the insulating sheet of the battery of the embodiment or the battery of the first modification example or the second modification example.

In the above-described embodiment and the modification examples, the lithium ion secondary battery was described as an example, but it is not limited thereto. The embodiment and the modification examples are applicable to a secondary battery or a primary battery that uses another active material as long as the battery uses a laminated electrode body. Furthermore, the embodiment and the modification examples are applicable to not only a lamination type battery but also a winding type battery without departing from the gist of the invention. For example, the embodiment and the modification examples are applicable to a winding type battery having a shape in which the laminated electrode body is rounded into a cylindrical shape and the laminated electrode body that is rounded is inserted into a cylindrical battery container in a state in which an insulating sheet (having the opening 14 that is formed) is wound around the laminated electrode body.

### INDUSTRIAL APPLICABILITY

The invention relates to a battery including: a laminated electrode body in which a positive electrode plate and a negative electrode plate are laminated through a separator; a battery container that accommodates the laminated electrode body; an electrolytic solution that is accommodated in the battery container; and an insulating sheet that is configured to serve as an insertion guide during accommodation of the laminated electrode body in the battery container, and is disposed between the laminated electrode body that is accommodated and the battery container, and has an opening formed to be adjacent to the bottom of the battery container in a state where the insulating sheet is disposed between the laminated electrode body and the battery container, wherein convection of the electrolytic solution is promoted by the opening. According to the invention, it is possible to provide a battery in which heat dissipation from the central portion of the battery container to the outside of the battery container is effectively performed, and thus failure of the battery (a decrease in battery performance, shortening of lifespan, and the like) is suppressed.

### DESCRIPTION OF THE REFERENCE SYMBOLS

1: Battery

2: Battery block

3: Laminated electrode body

4: Sac-like separator

5: Negative electrode plate

6: Positive electrode plate

7: Insulating sheet

8: Insulating sheet

9: Insulating sheet

10: Negative electrode tab

11: Positive electrode tab

12: Insulating tape

13: Insulating tape

14: Opening

15: Opening

16: Container main body

17: Lid

18: Battery container

19: Positive electrode terminal

20: Negative electrode terminal

21: Positive electrode lead

22: Negative electrode lead

23: Safety valve

24: Liquid injection port

25: Liquid surface of electrolytic solution

26: Insulating sheet

27: Insulating sheet

28: Insulating sheet

27′: Insulating sheet

28′: Insulating sheet

29: Concave portion (groove portion)

30: Penetration hole

31: Convex portion

1. A battery comprising: a laminated electrode body in which a positive electrode plate and a negative electrode plate are laminated through a separator; a battery container that accommodates the laminated electrode body; an electrolytic solution that is accommodated in the battery container; and an insulating sheet that is configured to serve as an insertion guide during accommodation of the laminated electrode body in the battery container, and is disposed between the laminated electrode body that is accommodated and the battery container, and has an opening formed to be adjacent to the bottom of the battery container in a state where the insulating sheet is disposed between the laminated electrode body and the battery container, wherein convection of the electrolytic solution is promoted by the opening.

2. The battery according to claim 1, wherein the opening is formed by cutting away a part of a side of the insulating sheet that is closest to the bottom of the battery container.

3. The battery according to claim 1, wherein a groove that faces an inner wall of the battery container is formed in the insulating sheet.

4. The battery according to claim 3, wherein the insulating sheet is further provided with a convex portion, and a space between the bottom of the battery container and the laminated electrode body is formed due to the convex portion.

5. The battery according to claim 4, wherein a penetration hole is formed in the insulating sheet.

6. The battery according to claim 5, further comprising: an insulating tape, wherein the insulating sheet includes first and second insulting sheets, and a state in which the laminated electrode body is interposed and pressurized between the first and second insulating sheets is maintained by adhering the insulating tape to the first and second insulating sheets.

7. The battery according to claim 2, wherein a groove that faces an inner wall of the battery container is formed in the insulating sheet.

8. The battery according to claim 7, wherein the insulating sheet is further provided with a convex portion, and a space between the bottom of the battery container and the laminated electrode body is formed due to the convex portion.

9. The battery according to claim 8, wherein a penetration hole is formed in the insulating sheet.

10. The battery according to claim 9, further comprising: an insulating tape, wherein the insulating sheet includes first and second insulating sheets, and a state in which the laminated electrode body is interposed and pressurized between the first and second insulating sheets is maintained by adhering the insulating tape to the first and second insulating sheets.
